(19) United States
(12) Patent Application Publication
(10) Pub. No.: US 2007/0251957 A1
(43) Pub. Date: Nov. 1, 2007

(54) Food extrusion piston assembly

(76) Inventor: Yu-Cheng Chen, Taichung Hsien (TW)

Correspondence Address: HERSHKOVITZ & ASSOCIATES, 2845 DUKE STREET, ALEXANDRIA, VA, 22314, US

(21) Appl. No.: 11/414,196

(22) Filed: May 1, 2006

(51) Int. Cl. G01F 11/00; B65D 88/54

(52) U.S. Cl. 222/386; 222/333; 222/390

(57) ABSTRACT

A food extruder has a base, a housing, a drive assembly, a food reservoir and a piston assembly. The piston assembly has a piston rod, a piston dish, a fastener and a spring. The piston rod slidably extends into the food reservoir and has a rod, and a rack. The rod has an upper and lower end and at least one flat surface formed at one or respectively at two ends of the rod. The rack is formed on the rod between the ends of the rod adjacent to the at least one flat surface. The piston dish is attached to the lower end of the piston rod and has a through hole. The fastener is extends through the through hole in the piston dish and connects to the lower end of the rod. The spring is mounted around the piston rod near the upper end of the rod.

### BACKGROUND OF THE INVENTION

1. Field of the Invention

The present invention relates to a piston assembly, and more particularly to a food extrusion piston assembly that is safely and convenient to use.

2. Description of Related Art

With reference to FIGS. 7 to 10, a conventional food extruder (60) in accordance with the prior art comprises a base (61), a housing (62), a drive assembly (63), a food reservoir (64) and a piston assembly (65).

The base (61) has a top surface.

The housing (62) is attached to and protrudes up from the base (61) and has two side panels (66) and an upper bracket (67). The side panels (66) are mounted parallel to each other on the base (61) and each side panel (66) has a top end and an inside surface. The upper bracket (67) is U-shaped, is attached to the inside surfaces of the side panels (66) at top ends and has a top surface, a bottom surface, a front surface and an upper through hole and a lower through hole. The upper and lower through holes are formed respectively through the top and bottom surfaces of the upper bracket (67).

The drive assembly (63) is driven by electric power, is attached to one of the side panels (66) between the upper and lower surfaces of the upper bracket (67) and has a dual-gear gearwheel (68). The dual-gear gearwheel (68) is mounted rotatably in the upper bracket (67) and has a bull gear (681) and a pinion (682). The bull gear (681) has an inside surface. The pinion (682) is mounted concentrically on and protrudes in from the inside surface of the bull gear (681).

The food reservoir (64) is hollow and cylindrical, is mounted between the side panels (66) of the housing (62) between the base (61) and the upper bracket (67) and has an open upper end, a closed bottom end, a chamber, an inner surface and a stuffing pipe (641). The open end of the food reservoir (64) faces the upper bracket (67) near the dual-gear gearwheel (68). The closed end of the food reservoir (64) is near the base (61). The chamber is defined inside the food reservoir (64) and holds food. The stuffing pipe (641) is attached to the closed end of the food reservoir (64) and communicates with the chamber.

The piston assembly (65) engages and is driven by the drive assembly (63), extends into the food reservoir (64) and has a piston rod (651) and a piston dish (652). The piston rod (651) is a rack (6511) engaging and driven by the pinion (682) of the drive assembly (63), is mounted slidably through the through holes in the upper bracket (67), extends moveably into the chamber of the food reservoir (64) and has an upper end and a lower end. The upper end of the piston rod (651) extends through the upper bracket (67) and protrudes from the through hole in the top surface. The lower end of the piston rod (651) extends into the chamber of food reservoir (64). The piston dish (652) is circular, may be a disk or a cylinder, corresponds to and is slidably mounted inside the chamber of the food reservoir (64), is attached to the lower end of the piston rod (651) and presses food in the chamber of the food reservoir (64) through the stuffing pipe (641) when the drive assembly (63) drives the piston (652) down.

However, the conventional food extruder (60) has the following defects and shortcomings.

1. The rack (6511) is formed on the piston rod (651) from the upper end to the lower end, which will increase the cost of manufacturing the food extruder (60).

2. When the piston assembly (65) is in use, the drive assembly (63) makes the piston rod (651) and the piston dish (652) move down. However, the piston dish (652) may knock against the closed bottom of the food reservoir (64) and cause the food reservoir (64) wear down or deform after a long time. In addition, the upper end of the piston rod (651) may knock against and damage the top surface of the upper bracket (67).

3. When the drive assembly (63) acts to retract the piston rod (651) and the piston dish (652) from the open top of the food reservoir (64), the piston dish (652) may knock against and wear or damage the bottom surface of the upper bracket (67) after a long time. Furthermore, the piston dish (652) knocking against the upper bracket (67) and may generate noise and shake the food extruder (60).

To overcome the shortcomings, the present invention provides a piston assembly for a food extruder to mitigate or obviate the aforementioned problems.

### SUMMARY OF THE INVENTION

The main objective of the present invention is to provide a food extruder piston assembly, which is safely and convenient to use.

The food extruder has a base, a housing, a drive assembly, a food reservoir and a piston assembly. The piston assembly has a piston rod, a piston dish, a fastener and a spring. The piston rod slidably extends into the food reservoir and has a rod, and a rack. The rod has an upper and lower end and at least one flat surface formed at one or respectively at two ends of the rod. The rack is formed on the rod between the ends of the rod adjacent to the at least one flat surface. The piston dish is attached to the lower end of the piston rod and has a through hole. The fastener is extends through the through hole in the piston dish and connects to the lower end of the rod. The spring is mounted around the piston rod near the upper end of the rod.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a food extruder in accordance with the present invention;

FIG. 2 is an operational front view in partial section of the food extruder with a piston assembly in FIG. 1;

FIG. 3 is an exploded perspective view of the piston assembly of the food extruder in FIG. 2;

FIG. 4 is a further exploded perspective view of the piston assembly of the food extruder in FIG. 3;

FIG. 5 is an operational side view in partial cross of the food extruder and the piston assembly in FIG. 1 showing that the piston assembly is pressed into a food reservoir of the food extruder;

FIG. 6 is an operational side view in partial section of the food extruder with the piston assembly in FIG. 1 showing that the piston assembly is retracted out of the food reservoir;

FIG. 7 is a perspective view of a conventional food extruder in accordance with the prior art;

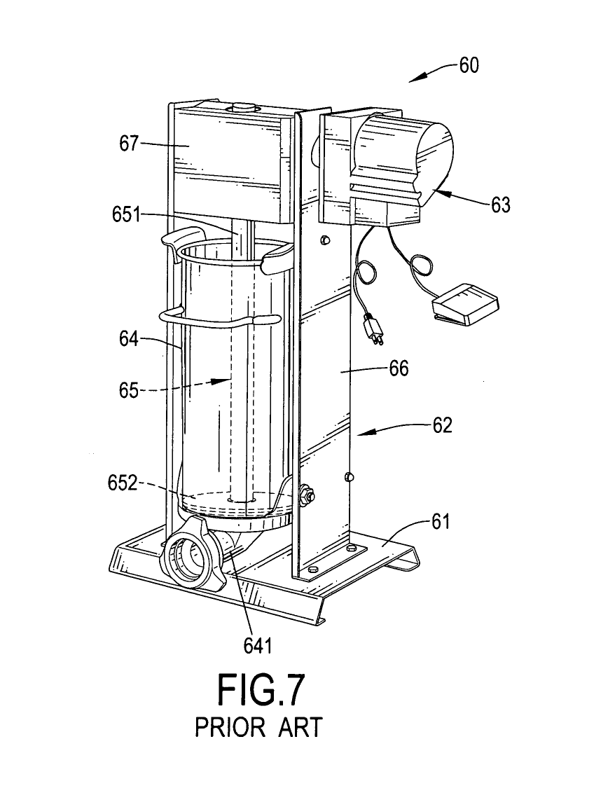

FIG. 8 is an operational front view in partial section of the conventional food stuffer in FIG. 7;

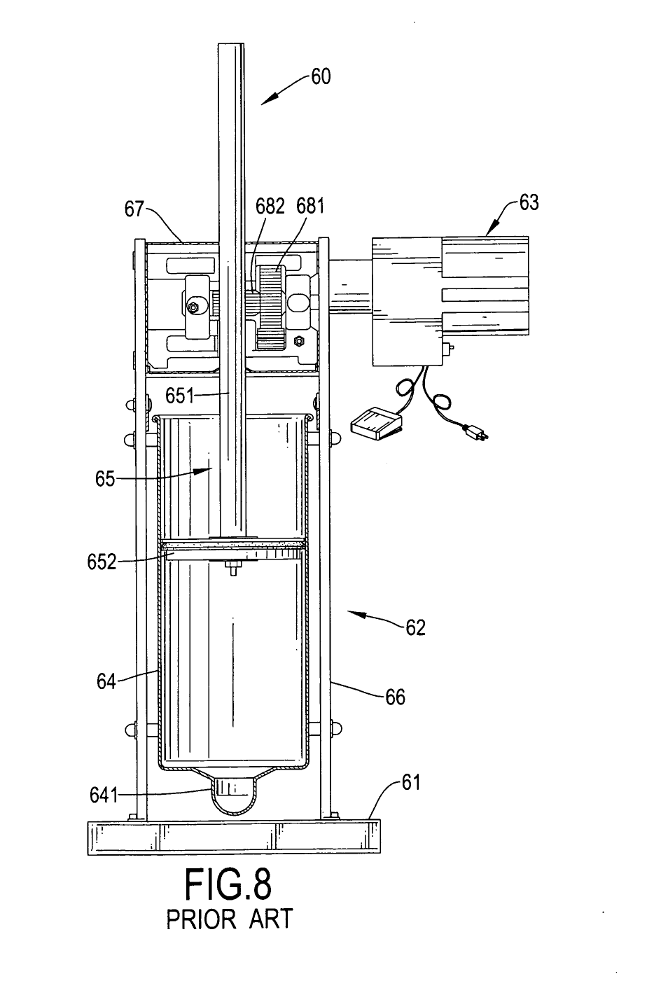

FIG. 9 is an operational side view in partial section of the conventional food extruder in FIG. 7 with the piston assembly being pressed into the food reservoir; and

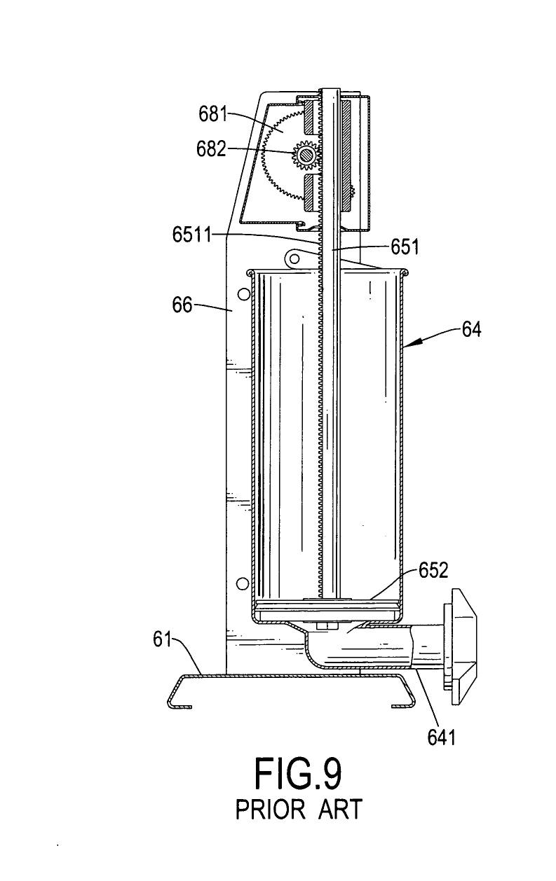

FIG. 10 is an operational side view in partial section of the conventional food extruder in FIG. 7 with the piston assembly being moved out the food reservoir.

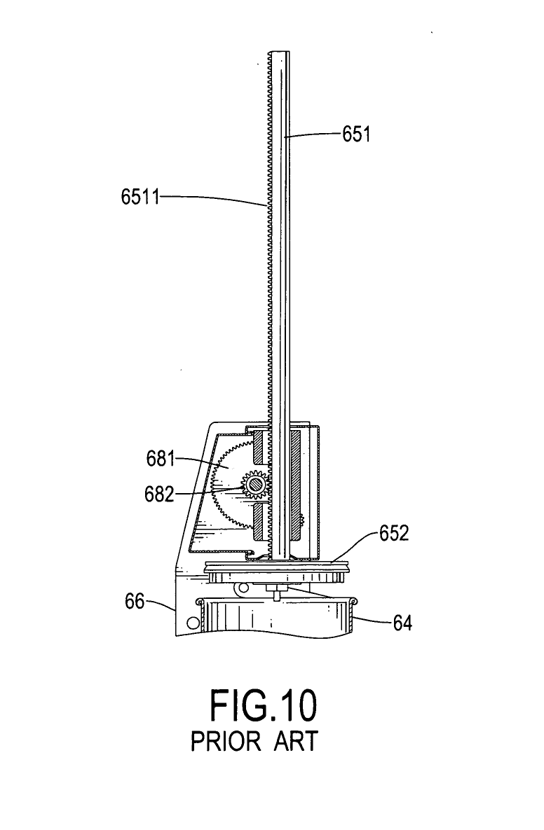

### DETAILED DESCRIPTION OF THE PREFERRED EMBODIMENT

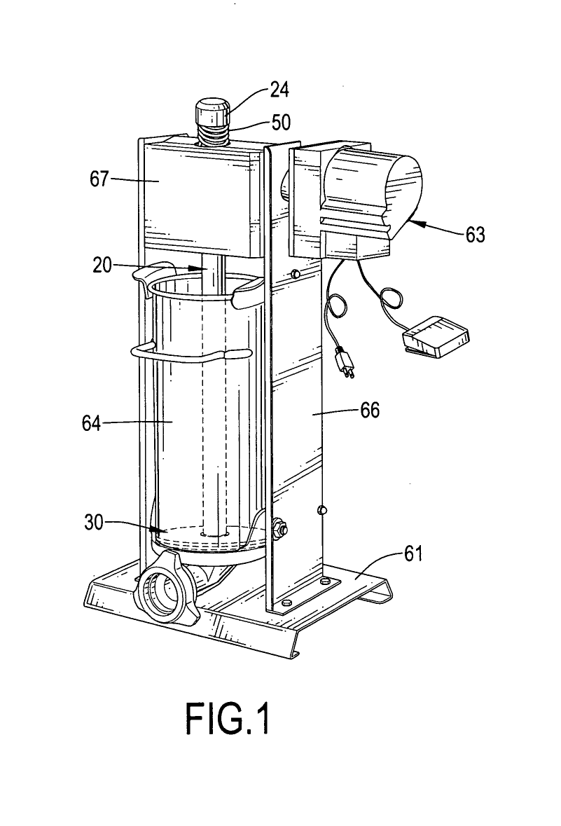

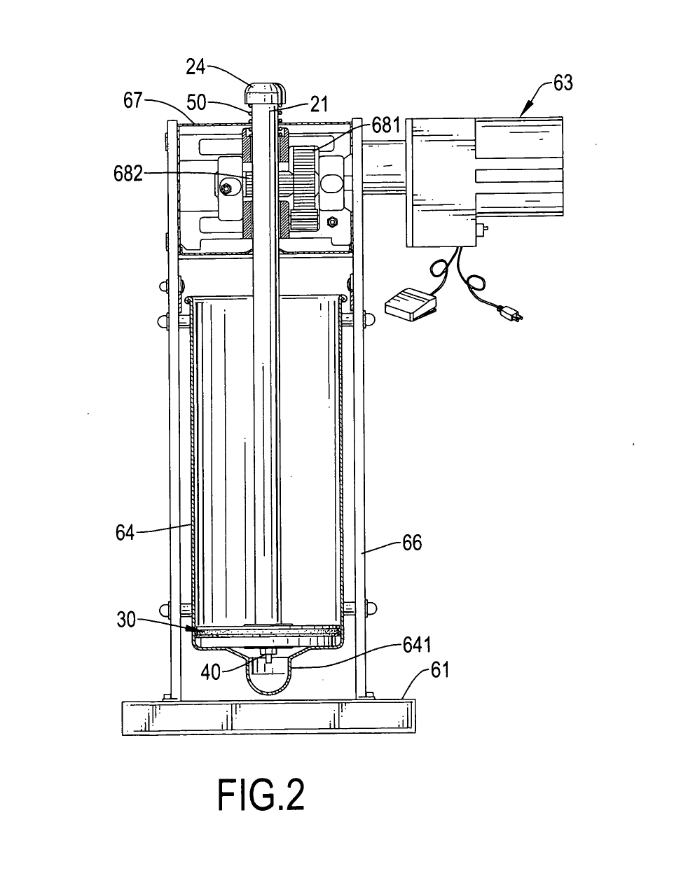

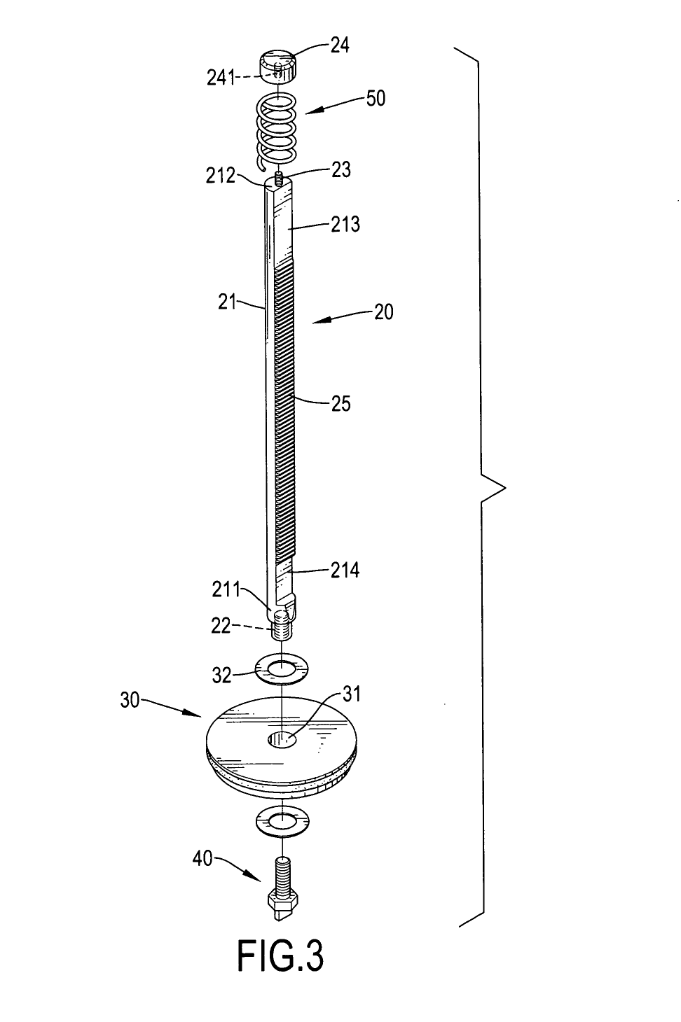

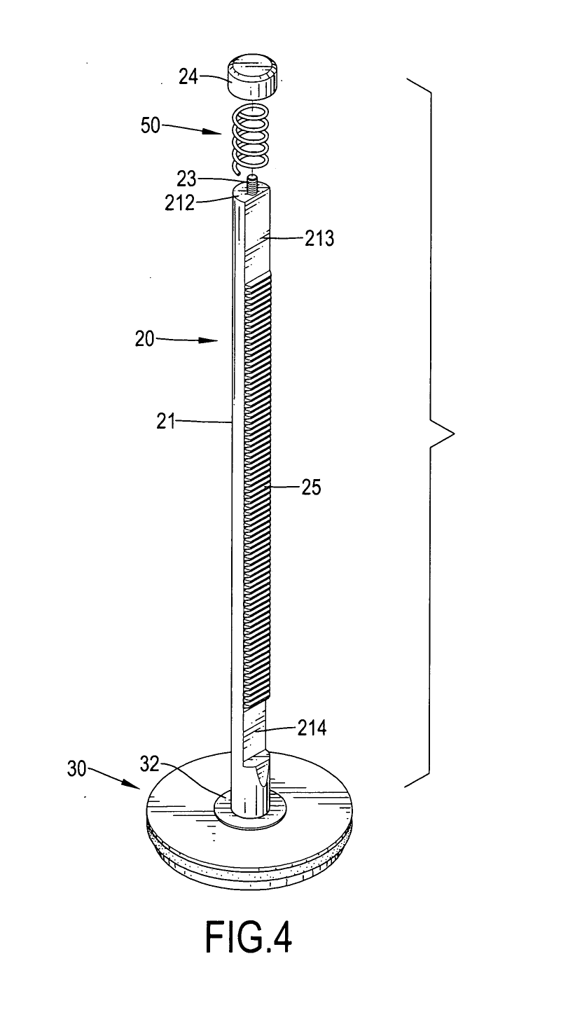

With reference to FIGS. 1 to 4, a food extruder (60) in accordance with the present invention comprises a base (61), a housing (62), an drive assembly (63), a food reservoir (64) and a piston assembly pressing food out of the food reservoir (64). The base (61), housing (62), drive assembly (63) and food reservoir (64) may be conventional. Except to introduce their features, no further description is provided to reduce redundancy.

The housing (62) has two side panels (66) and an upper bracket (67). Each side panel (66) has a top end and an inside surface. The upper bracket (67) is U-shaped and has a top surface, a bottom surface, a front surface and an upper through holes and a lower through hole.

The drive assembly (63) is driven by electrical power and has a dual-gear gearwheel (68). The dual-gear gearwheel (68) has a bull gear (681) and a pinion (682).

The food reservoir (64) is hollow and cylindrical and has an open upper end, a closed bottom end, a chamber, an inner surface and a stuffing pipe (641).

The piston assembly comprises a piston rod (20), a piston dish (30), a fastener (40) and a spring (50). The piston rod (20) is mounted slidably in the upper and lower through holes in the upper bracket (67), protrudes from the upper through hole, selectively extends into the chamber of the food reservoir (64) and has a rod (21), a connecting hole (22), an optional mounting shaft (23), an optional end cap (24) and a rack (25).

The rod (21) is mounted slidably through the upper and lower through holes in the upper bracket (67), protrudes from the upper through hole, selectively extends into the chamber of the food reservoir (64) and has a lower end (211), an upper end (212) and at least one flat surface (213, 214). The lower end (211) selectively extends into the chamber of the food reservoir (64). The upper end (212) extends through and protrudes from the upper through hole in the upper bracket (67) The at least one flat surface (213, 214) formed at one or both ends of the rod (21) and may be an upper flat surface (213), a lower flat surface (214) or an upper flat surface (213) and a lower flat surface (214). The upper flat surface (213) is formed longitudinally at the upper end (212) of the rod (21). The lower flat surface (214) is formed longitudinally at the lower end (211) of the rod (21) and aligns with the upper flat surface (213).

The connecting hole (22) is formed coaxially in the lower end (211) of the piston rod (20) and may have an internal thread.

The mounting shaft (23) is formed on protrudes coaxially from the upper end (212) of the piston rod (20) and may be threaded.

The end cap (24) is attached securely to the mounting shaft (23), is larger than the upper through hole in the top surface of the upper bracket (67), keeps the piston assembly from striking the closed bottom end of the food reservoir (64) and has a bottom surface and a connecting hole (241). The connecting hole (241) is formed on the bottom surface of the end cap (24), mounts securely on the mounting shaft (23) and may have an internal thread. The internal thread screws onto the threaded mounting shaft (23).

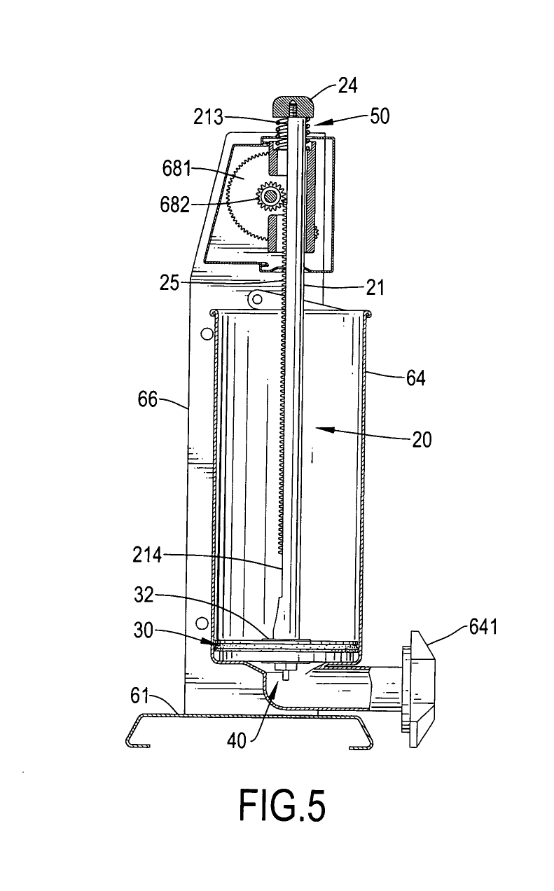

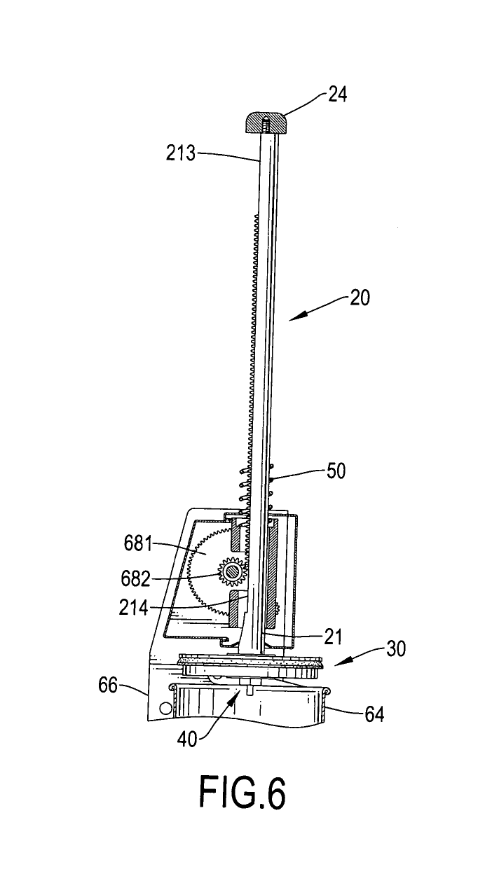

The rack (25) is formed on the rod (21) between the upper and lower ends of the rod (21) and adjacent to the at least one flat surface (213, 214), may be formed between the upper flat surface (213) and the lower flat surface (214) and engages the pinion (682) of the dual-gear gearwheel (68) to extend or retract the piston assembly when the drive assembly (63) drives. With further reference to FIGS. 5 and 6, the rack (25) disengages from the pinion (682) when the pinion (682) reaches the upper and lower flat surfaces (213, 214) so the piston assembly will not strike the closed bottom end of the food reservoir (64) or the bottom surface of the upper bracket (67).

The piston dish (30) is circular, may be a disk or a short cylinder, is attached to lower end (211) of the piston rod (20) and has a center, a top, a bottom, a through hole (31) and two optional washers (32). The through hole (31) is formed through the center of the piston dish (30), abuts the lower end (211) of the rod (21) and aligns with the connecting hole (22) in the rod (21). The washers (32) are mounted around the through hole (31) in the piston (30) respectively on the top and bottom of the piston (30).

The fastener (40) extends through the washers (32) and the through hole (31), extends into and connects securely to the connecting hole (22) in the rod (21), may have an external thread and may be a bolt. The external thread screws into the internal thread in the connecting hole (22).

The spring (50) is mounted around the piston rod (20) between the top surface of the upper bracket (67) and the upper end (212) of the rod (21), presses the piston rod (20) up so the rack (25) will engage the pinion (682) and abuts the end cap (24) to keep the end cap (24) from striking the upper surface of the upper bracket (67).

The piston assembly of the food extruder (60) in accordance with the present invention has the following advantages.

1. The rack (25) is formed on the rod (21) between the upper flat surface (213) and the lower flat surface (214), which will decrease the cost of manufacturing.

2. The upper flat surface (213) causes the pinion (682) to disengage from the rack (25) so the piston (30) will not be driven into and strike the closed bottom end of the food reservoir (64), and the spring (50) keeps the end cap (24) from striking the top surface of the upper bracket (67). Consequently, potential damage to food extruder (60) by the piston assembly is greatly reduced.

3. The lower flat surface (214) causes the pinion (682) to disengage from the rack (25) so the piston (30) will not be driven into and will not strike the bottom surface of the upper bracket (67). Consequently, noise and shaking during operation of the food extruder (60) and potential damage to the bottom surface of the upper bracket (67) will be greatly reduced.

Even though numerous characteristics and advantages of the present utility model have been set forth in the foregoing description, together with details of the structure and features of the utility model, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A food extruder having
a base;
a housing attached to, protruding up from the base and having
two side panels mounted parallel to each other and each side panel having
a top end; and
an inside surface; and
an upper bracket attached to the inside surfaces at the top ends of the side panels and having
a top surface with an upper through hole; and
a bottom surface with a lower through hole;
a drive assembly attached to one of the side panels between the upper and lower surfaces of the upper bracket and having
a dual-gear gearwheel mounted rotatably in the upper bracket and having
a bull gear has an inside surface; and
a pinion mounted concentrically on and protruding from the inside surface of the bull gear;
a food reservoir mounted between the side panels of the housing between the base and the upper bracket and having
an open top end facing the upper bracket near the dual-gear gearwheel;
a closed bottom end nears the base; and
a cavity defined inside the food reservoir; and
a piston assembly being engaged and driven by the drive assembly, extending into the food reservoir to press food out of the food reservoir and having
a piston rod mounted slidably in the upper and lower through holes in the upper bracket, protruding from the upper through hole, selectively extending into the chamber of the food reservoir and having
a rod mounted slidably through the upper and lower through holes in the upper bracket, protruding from the upper through hole, selectively extending into the chamber of the food reservoir and having
a lower end selectively extending into the chamber of the food reservoir;
an upper end extending through and protruding from the upper through hole in the upper bracket; and
at least one flat surface formed longitudinally at one end of the rod;
a connecting hole formed coaxially in the lower end of the piston rod; and
a rack formed on the rod between the upper and lower ends of the rod adjacent to the at least one flat surface and engaging the pinion of the dual-gear gearwheel to extend or retract the piston assembly when the drive assembly is driving;
a piston dish being circular and attached to the lower end of the piston rod and having
a center;
a top;
a bottom; and
a through hole formed through the center of the piston dish and abutting the lower end of the rod and aligning with the connecting hole in the rod;
a fastener extending through the through hole and extending into and connecting securely to the connecting hole in the rod; and
a spring mounted around the piston rod between the top surface of the upper bracket and the upper end of the rod and pressing the piston rod up.

2. The food extruder as claimed in claim 1, wherein
the piston rod further has a mounting shaft formed on and protruding coaxially from the upper end of the piston rod; and
an end cap attached securely to the mounting shaft, being larger than the upper through hole in the top surface of the upper bracket to keep the piston assembly from striking the closed bottom end of the food reservoir and having
a bottom surface; and
a connecting hole formed on the bottom surface of the end cap and mounting securely on the mounting shaft;
the at least one flat surface on the rod of the piston rod comprises a lower flat surface formed longitudinally at the lower end of the rod; and
the rack is formed between the lower flat surface and the upper end of the rod.

3. The food extruder as claimed in claim 1, wherein the piston further has two washers mounted around the through hole in the piston rod respectively on the top and bottom of the piston rod.

4. The food extruder as claimed in claim 1, wherein
the at least one flat surface of the rod of the piston rod comprises an upper flat surface formed longitudinally at the upper end of the rod; and
the rack is formed between the upper flat surface and the lower end of the rod.

5. The food extruder as claimed in claim 1, wherein
the at least one flat surface of the rod of the piston rod comprises
an upper flat surface formed longitudinally at the upper end of the rod; and
a lower flat surface formed longitudinally at the lower end of the rod and aligning with the upper flat surface; and
the rack is formed between the upper flat surface and the lower flat surface.

6. The food extruder as claimed in claim 1, wherein
the connecting hole in the lower end of the piston rod has an internal thread;
the fastener has an external thread screwing into the internal thread in the connecting hole.

7. The food extruder as claimed in claim 1, wherein
the mounting shaft is threaded; and
the connecting hole in the end cap has an internal thread screwing onto the threaded mounting shaft.

8. The food extruder as claimed in claim 2, wherein the piston dish is a disk.

9. The food extruder as claimed in claim 2, wherein the piston further has two washers mounted around the through hole in the piston rod respectively on the top and bottom of the piston rod.

10. The food extruder as claimed in claim 2, wherein the fastener is a bolt.
